(19) United States
(12) Patent Application Publication
(10) Pub. No.: US 2010/0087987 A1
(43) Pub. Date: Apr. 8, 2010

(54) Apparatus and Method for Vehicle Driver Recognition and Customization Using Onboard Vehicle System Settings

(75) Inventors: Jihua Huang, Sterling Heights, MI (US); William C. Lin, Birmingham, MI (US); Yuen-Kwok Chin, Troy, MI (US)

Correspondence Address: Quinn Law Group, PLLC, 39555 Orchard Hill Place, Suite 520, Novi, MI, 48375, US

(73) Assignee: GM GLOBAL TECHNOLOOGY OPERATIONS, INC., Detroit, MI (US)

(21) Appl. No.: 12/247,349

(22) Filed: Oct. 8, 2008

(51) Int. Cl. G06F 17/00; G05B 19/00

(52) U.S. Cl. 701/36; 701/49

(57) ABSTRACT

A vehicle includes vehicle systems each having driver-selectable vehicle system settings (VSS), and a control system for statistically modeling the VSS to determine an identity of a driver. The control system automatically controls a setting of at least one of the vehicle systems using or based on the identity. The control system statistically models the VSS for the driver over time to produce a historical driver profile (HDP) for the driver, and can automatically update the HDP when said driver manually changes any one of the VSS. An optional driver identification device can verify the identity. A method for controlling a predetermined onboard system of a vehicle includes collecting a set of VSS for a plurality of onboard systems, processing the VSS through a statistical modeling algorithm to determine an identity of a driver of the vehicle, and automatically controlling a predetermined onboard system using the identity of the driver.

### TECHNICAL FIELD

The present invention relates generally to the automated control of onboard vehicle systems, and in particular to an apparatus and method for identifying an authorized driver of a vehicle using onboard system settings and then controlling an onboard vehicle system in accordance with a modeled profile of the authorized driver.

### BACKGROUND OF THE INVENTION

Modem vehicle design strives to achieve a seamless interaction between the architecture of various onboard vehicle systems and an operator or driver of the vehicle. Generally, interaction between the vehicle systems and a driver can be divided into three levels or classifications: access, accommodation, and dynamic control. With respect to access, the vehicle system can be configured such that only certain authorized drivers can operate the vehicle. With respect to accommodation, the vehicle's interior and/or exterior systems can be adjusted in conjunction with known preferences of the driver. With respect to dynamic control, the vehicle's dynamic characteristics can be uniquely tailored to the known preferences of its present driver.

In particular, access can be controlled by granting a potential driver access to a vehicle only if that driver has a portable device such as a key fob, a radio frequency identification (RFID) device or tag, etc. However, possession of the portable device may allow some unauthorized drivers access the vehicle. To enhance overall vehicle security, a popular trend is to employ driver identification methodologies to further verify the authority of a potential driver with respect to the vehicle. Some exemplary state-of-the-art driver identification methodologies and security measures include identifying the unique biometric characteristics of the driver, e.g., the driver's fingerprints, finger veins, iris patterns, retinal patterns, handprints, voice recognition, facial recognition, speech recognition, etc. Once affirmatively identified in this manner, the driver is considered to be authorized, and the vehicle can be accessed by that driver. However, biometric sensors and processing algorithms can add considerable cost and complexity to a vehicle.

Regarding accommodation and dynamic control, some vehicles allow each operator or driver of the vehicle to record his or her preferred vehicle system settings, driving preferences, and/or driving style within an individual user profile, with each driver selecting from among the stored user profiles upon entering the vehicle. Once a desired profile is selected, an electronic control unit or controller retrieves the corresponding setting information for various vehicle systems and adjusts the associated control settings accordingly. As with the access methods described above, preset profiles can require the affirmative selection of a profile, with the profiles being static values. However, despite the many technical advances in the levels or classifications of access, accommodation, and dynamic control as described above, existing vehicle systems and control methods remain less than optimal, particularly as they relate to the automatic and seamless customization of vehicle systems settings for a given driver over a variety of driving conditions.

### SUMMARY OF THE INVENTION

Accordingly, a method and apparatus provide adaptive driver recognition based on a driver's present vehicle settings and automatic control of an onboard vehicle system using that driver's identity. That is, the method and apparatus can statistically-model certain highly descriptive or sensitive vehicle settings along with discrete vehicle settings to generate a historical vehicle system setting profile unique to that particular driver, with this profile referred to hereinafter as the historical driver profile (HDP) for simplicity.

More specifically, adaptive in-vehicle “learning” of an authorized driver's preferred vehicle system settings is provided by continuously monitoring the driver's vehicle system settings over time and over a range of driving conditions, and then statistically modeling sensitive vehicle settings as described below to generate the HDP for that particular driver. Along with the modeled settings, the HDP can also include discrete vehicle settings, such as relatively consistent settings, on/off settings, etc. An authorized driver is then affirmatively recognized using the currently selected VSS, i.e., those settings that the driver chooses or selects upon entering the vehicle, with the HDP being updated using the currently selected VSS and any modifications thereto. Over time, such as during a number of future trips taken by the same authorized driver over different driving conditions, additional information regarding the VSS can be correlated to the HDP for that driver to further optimize the accuracy of the HDP. Once the driver is identified, various autonomous or automatic control actions can be taken, such as automatically adjusting or customizing certain other vehicle system settings using the HDP for that driver.

In particular, a vehicle includes a plurality of vehicle systems each having a set of driver-selectable or driver-adjustable vehicle system settings (VSS), and a control system operable for determining an identity of one of a plurality of authorized drivers of the vehicle using the VSS. The control system automatically executes a vehicle control action, such as automatically updating one or more VSS during the course of a trip or over several trips, using the identity of the driver. The control system can statistically model a predetermined set of the most sensitive of the VSS for each authorized driver over time to thereby produce the HDP for each driver. The predetermined set of the most sensitive of the VSS can include without being limited to: seat position, mirror position, pedal position, steering wheel position, suspension settings, climate control settings, etc. The HDP can be further optimized by including a set of discrete VSS in the HDP, such as radio or other entertainment system settings, seat warmer on/off status, moon roof open/closed status, etc., and the mean and variance of such VSS where appropriate, as described below.

The control system has a driver recognition algorithm which includes each of a feature extraction subprocess, a feature selection subprocess, and a feature classification subprocess. In one exemplary embodiment, the feature extraction subprocess is a Linear Discriminant Analysis (LDA) subprocess, and the feature classification process is a Gaussian Mixture Model (GMM) subprocess, although other subprocesses capable of uniquely identifying the driver by comparing a set of VSS to a modeled HDP for that driver are also usable within the scope of the invention.

A method for automatically controlling a vehicle system includes collecting the set of driver-selectable VSS, processing predetermined sensitive settings of the VSS through a statistical modeling algorithm to determine an identity of a driver of the vehicle, and executing a vehicle control action corresponding to that identity. Collecting the set of VSS can detect a driver-selectable or driver-adjustable VSS of one or more vehicle systems, with the term “selectable” referring to such discrete settings as radio stations and “adjustable” referring to variable setting such as mirror positions. VSS can include by way of example: mirrors, seats, pedals, steering wheel, radio, HVAC systems, etc., with a predetermined set of the more sensitive of the settings used in the statistical model. Processing the set of VSS includes consolidating the set of VSS to form an original feature vector collectively describing the VSS, transforming the original feature vector using a feature extraction subprocess to thereby generate a new feature vector, and processing the new feature vector through a feature selection subprocess to thereby generate a final feature vector. The final feature vector can be processed through a classification subprocess to thereby determine the identity of the driver.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle having an automatic driver recognition and settings control system or DRSC system in accordance with the invention;

FIG. 2 is a schematic illustration of a DRSC system usable with the vehicle of FIG. 1; and

FIG. 3 is a schematic logic flow diagram describing an algorithm or method for use with the DRSC of FIG. 2.

### DESCRIPTION OF THE PREFERRED EMBODIMENTS

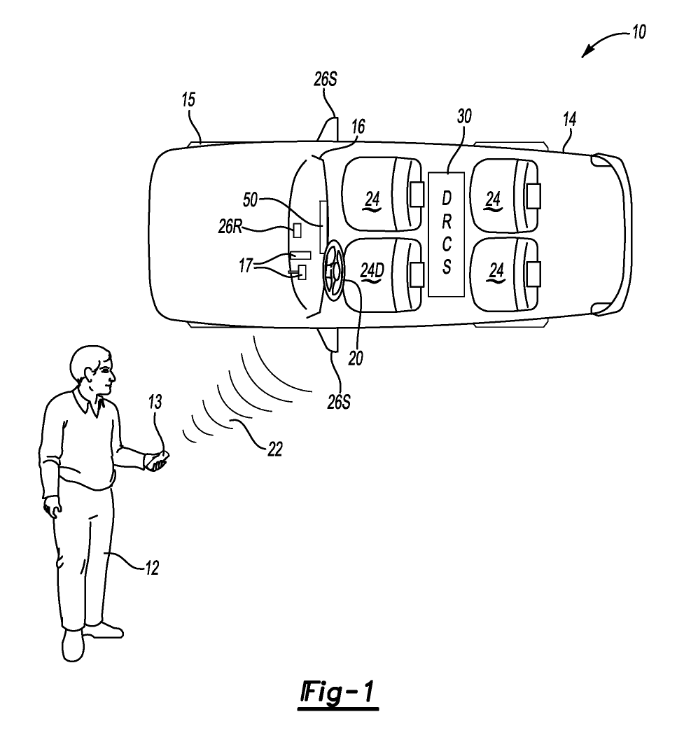

With reference to the Figures, wherein like reference numerals refer to like or similar components throughout the several figures, and beginning with FIG. 1, a vehicle 10 includes an interior 14 and a set of road wheels 15. Seats 24 including an operator or driver seat 24D are mounted within the interior 14 and configured to transport a plurality of passengers (not shown). A driver seat 24D in particular is positioned facing an instrument panel 16 and a steering wheel 20 or other suitable steering input device.

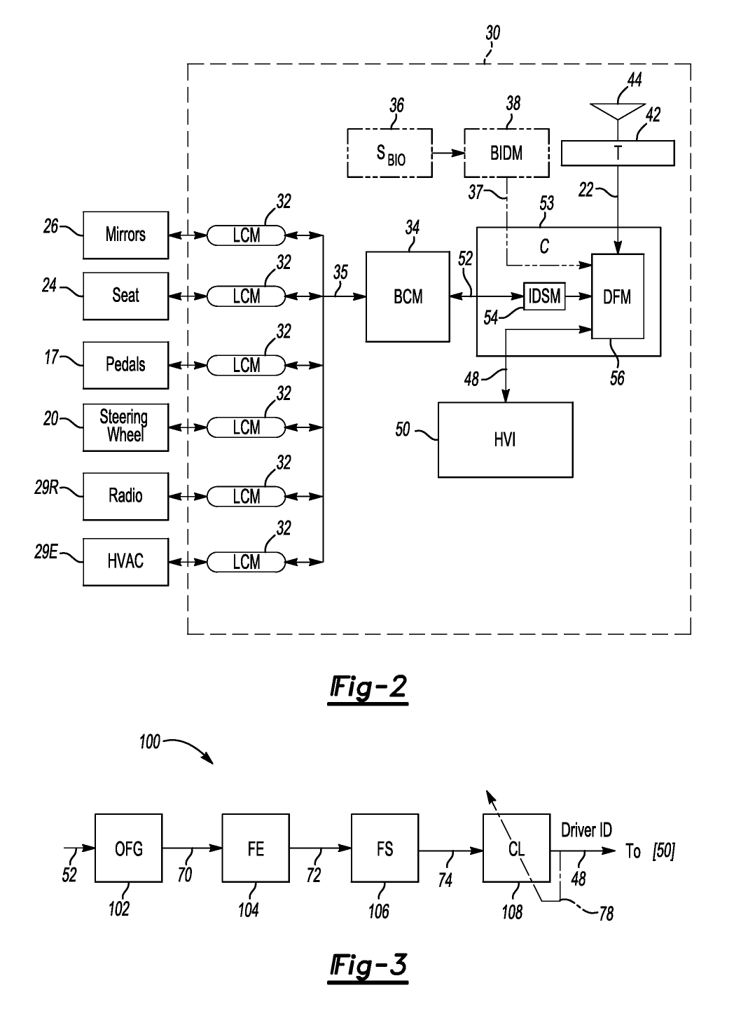

The vehicle 10 includes various systems or devices, each of which is at least partially adjustable or repositionable by an authorized driver 12 of the vehicle 10 in order to provide a driving experience that is uniquely tailored to that particular driver. For example, the vehicle 10 can include adjustable side mirrors 26S, a rear-view mirror 26R, an input panel or human-vehicle interface (HVI) 50, control pedals 17, the steering wheel 20, etc. For dynamic control of the vehicle 10, the pedals 17 can include a throttle or accelerator pedal and a brake pedal, and could optionally include a clutch pedal when the vehicle 10 is configured with a manual transmission. Although not shown in FIG. 1 for simplicity, those of ordinary skill in the art will recognize that each vehicle system described above can be configured with an actuator and positional sensors, and can be locally controlled using a dedicated local control module or LCM 32 (see FIG. 2).

The HVI 50 itself can be adapted to house or include various control switches, knobs, buttons, touch-screen interfaces, voice-recognition interfaces, or other suitably configured input devices allowing the manual selection of preferred settings for each of the various vehicle systems. In addition to the vehicle systems listed above, additional exemplary vehicle systems can include, without being limited to, heating, ventilation, and air conditioning (HVAC) controls, radio station and/or volume controls, compact disc (CD)/digital video disc (DVD)/MP3 controls, interior/exterior lighting controls, four-wheel/two-wheel drive mode setting controls, etc. For simplicity, the HVI 50 is shown in FIG. 1 as being an integral portion of the instrument panel 16, however the various controls can also be positioned anywhere within the interior 14 as needed to facilitate access by the driver 12 when the driver 12 is seated in the driver seat 24D.

The vehicle 10 also includes an automatic driver recognition and control system (DRCS) 30 that is adapted to identify or recognize an authorized driver 12 of the vehicle 10 based on a set of vehicle system settings or VSS as described below with reference to FIGS. 2 and 3, and to thereafter automatically and continuously model the driver's preferred VSS over time and over a wide variety of driving conditions. In one embodiment, a remote device 13 such as a key fob and/or an RFID tag generating and transmitting remote signals 22, a biometric sensor 36 (see FIG. 2), and/or other external or internal devices can be included as optional devices for verifying or validating the identity of the driver 12 as described below.

Referring to FIG. 2, the DRCS 30 of FIG. 1 is shown in more detail, and includes a transceiver (T) 42 having a receiver or antenna 44, the HVI 50, a Vehicle Body Control Module (BCM) 34, and a driver recognition and control setting (DRCS) controller 53 having an Identification Settings Module (IDSM) 54 and a Decision Fusion Module (DFM) 56 as described below, with the DRCS controller 53 referred to hereinafter as the controller 53 for simplicity. The transceiver 42 can sense or detect the remote signals 22 from the remote entry device 13 of FIG. 1 and transmit or route the remote signals 22 to the controller 53. The BCM 34 communicates with the individual LCM 32 each controlling an associated system of the vehicle 10, as described above with reference to FIG. 1. For example, an LCM 32 can be associated with each of the mirrors 26, i.e., the mirrors 26R, 26S of FIG. 1 or other controllable mirrors, the driver seat 24D, the pedals 17, the steering wheel 20, etc. Likewise, the HVI 50 of FIG. 1 can be used to control settings of other onboard systems such as a radio 29R, an HVAC system 29E, vehicle lighting systems, etc., as will be understood by those of ordinary skill in the art.

After the BCM 34 collects a set of local signals 35 from each LCM 32, the BCM 34 generates a collective set of vehicle system setting or VSS information 52. The VSS information 52 is relayed or transmitted to a setting-based driver identification module (IDSM) 54 of the controller 53. In addition to the VSS information 52, the controller 53 also received the remote signals 22 from the remote device 13 of FIG. 1, if any, and driver-selected input signals 48 from the HVI 50. The controller 53 can also receive driver biometric signals 37 that are detected, measured, or sensed by one or more biometric sensors (S_{BIO}) 36, if the vehicle 10 of FIG. 1 is so equipped, with the biometric signals 37 being processed through a biometric-based driver identification module (BIDM) 38.

The controller 53 recognizes the identity of the driver 12 of FIG. 1 based on a new set of vehicle settings selected upon entering the vehicle 10 using statistical modeling as described below. Driver recognition techniques based on the use of a remote entry device 13, such as RFID tagging, and using the unique biometric of the driver 12 are known to those skilled in the art, and therefore are not described in detail herein. However, where such optional devices are used, they can help verify or validate the identity of the driver 12 as determined via the method or algorithm 100 of the invention, as will be described below with reference to FIG. 3. Such devices may have particular utility in the initial training of the DRCS 30, and in particular the association of a predetermined set of relatively sensitive VSS to an identity of a particular driver 12.

The controller 53 can be configured as a general purpose digital computer generally comprising a microprocessor or central processing unit, read only memory (ROM), random access memory (RAM), electrically-programmable read only memory (EPROM), high speed clock, analog to digital (A/D) and digital to analog (D/A) circuitry, and input/output circuitry and devices (I/O), as well as appropriate signal conditioning and buffer circuitry. Each set of algorithms resident in the controller 53 or accessible thereby, such as the algorithm 100 of FIG. 3, is stored in ROM and executed to provide the respective functions of each resident controller.

Within the scope of the invention, if the optional BIDM 38 shown in phantom is included within the DRCS 30, such a device or devices can use the biometric sensors 36 (also shown in phantom) to gather a set of unique biometric characteristics of a driver 12, such as the driver's fingerprints, finger veins, iris patterns, retinal patterns, handprints, voice recognition, facial recognition, speech recognition, etc., and relay this information as the biometric signals 37. The optional BIDM 38 can further optimize the performance of the DRCS 30 as noted above. Whether or not a BIDM 38 is used, the DRCS 30 first performs a vehicle setting-based driver recognition function using the collective set of VSS information, i.e., the local signals 35, and then performs a decision fusion function within the DFM 56 that ultimately transforms or processes the initial driver recognition results in a particular manner, as will now be set forth in detail with reference to FIG. 3 together.

Referring to FIG. 3, the driver recognition function or algorithm 100 of the present invention based on driver-selected vehicle settings, i.e., the local settings 35, can be generally formulated as a pattern recognition problem. Given N drivers each with corresponding historical settings and new settings, the algorithm 100 should determine whether the new setting belongs to a known or previously validated driver or instead to a new driver. In other words, the driver recognition problem exemplified by the algorithm 100 can be solved by designing a classifier that classifies the new setting into one of the N+2 classes, with N classes representing the N drivers, the (N+1) class representing a new driver, and the (N+2) class representing a condition in which the classifier cannot accurately decide. Alternatively, the “cannot decide” class can be removed as a class, and the “new” setting can then be assigned to one of the N drivers or to a new driver.

FIG. 3 represents a logic flow of a pattern recognition process or algorithm 100 used to recognize authorized drivers based on their vehicle settings, represented by the VSS information of arrow 52. At step or logic block 102, the VSS information 52 selected by the driver 12 of FIG. 1 is measured or collected, and a set of original features (OFG) is generated. The original features of arrow 70 that are output from the step or logic block 102 alone may not provide the most efficient set of features for pattern recognition. Therefore, the original features (arrow 70) output from the step or logic block 102 are used as an input set for feature extraction (FE) at step or logic block 104. FE techniques create a transformed set of new features (arrow 72) based on a transformation or combination of the original features (arrow 70), and this set of transformed features (arrow 72) is output to step or logic block 106.

At step or logic block 106 a set of final features (arrow 74) is determined, with logic block 106 selecting an optimal subset of the original features (arrow 70) to further reduce a dimension of the final features (arrow 74). The final features (arrow 74) are then input to a classifier (CL) at step or logic block 108. The classifier (CL) determines the identity of a driver such as driver 12 of FIG. 1 accordingly using statistical modeling as set forth below.

Still referring to FIG. 3, the original feature generation (OFG) provided at step or logic block 102 takes the various settings describing the VSS information (arrow 52) and assembled this information as an original feature vector, i.e., the original features (arrow 70). For example, the settings of the VSS information (arrow 52) may include seat fore/aft position, height and/or back angle, and/or the seat cushion angle of the driver seat 24D, the steering wheel telescope setting, tilt angle, etc., of the steering wheel 20, position of any or all of the mirrors 26R, 26S, position of the pedals 17, radio station, volume, and acoustical settings of the radio 29R, HVAC settings of an HVAC system 29E, etc. These original features (arrow 70) can be stored as a vector that is referred to hereinbelow as the original feature vector oᵢ.

At step or logic block 104, i.e., the feature extraction (FE) step or logic block, the algorithm 100 conducts a transformation function on the original feature vector oᵢ (arrow 70) output from the step or logic block 102 to thereby generate a new feature vector qᵢ=f(oᵢ) as the transformed or new features (arrow 72). Various feature extraction techniques or methods can be used within the scope of the invention, e.g., Principle Component Analysis (PCA), Linear Discriminant Analysis (LDA), Kernel PCA, Generalized Discriminant Analysis (GDA), etc. For exemplary purposes, LDA can be used to show a linear transformation: qᵢ=U^{T}oᵢ, where oᵢ is an nₒ-by-1 vector, U is an nₒ-by-n_{q} _l matrix and qᵢ is an n_{q}-by-1 (n_{q}≦nₒ) vector with each row representing the value of the new features. The matrix U is determined off-line during a design phase, which will be described later hereinbelow.

At step or logic block 106, i.e., the feature selection (FS) step or logic block, the transformed or new features (arrow 72) are further processed to select an optimal subset of the new features, i.e., the final features (arrow 74). Various feature selection techniques can be used within the scope of the invention, e.g., Exhaustive Search, Branch-and-Bound Search, Sequential Forward/Backward Selection, and Sequential Forward/Backward Floating Search, can be used within the scope of the invention. The subset that yields the best or optimal performance is chosen as the final features (arrow 74) to be used for final driver classification.

For example, the resulting subset describing the final features (arrow 74) may consist of n features corresponding to the {l1 l2 . . . ln}(1≦l1≦l2≦ . . . ≦ln≦n_{q}) row of the feature vector qᵢ. The matrix U can be written or described as U=└u₁ u₂ . . . u_{nq}┘, with each vector being an nₒ-by-1 vector. The algorithm 100 selects only those vectors corresponding to the best or optimal subset, and therefore W=[uₗ₁ u₁₂ . . . uₗₙ], an nₒ-by-n matrix. Combining the feature extraction and feature selection, the final features (arrow 74) corresponding to the original feature vector oᵢ can be derived as xᵢ=W^{T}oᵢ. Within the scope of the invention, since the dimension of the extracted features (i.e., n_{q}) is relatively small, Exhaustive Search is used in one embodiment to evaluate the classification performance of each possible combination of the extracted features, which will be explained in detail hereinbelow.

At step or logic block 108, i.e., the classification (CL) step or logic block, the final features (arrow 74) are classified or compared to a population of modeled HDP to determine the identity of the driver 12 of FIG. 1, as represented by the driver ID arrow 55. The number of classes in a typical pattern recognition problem is usually known and fixed, while for an in-vehicle driver recognition problem as addressed by the present invention, the number of classes, i.e., the number of drivers N, is usually unknown and not fixed. For example, a vehicle 10 of FIG. 1 that is shared by various household members typically has multiple drivers, and the number of drivers is likely to be related to the number of eligible drivers in the household.

Additionally, typical pattern recognition problems usually have training patterns for the classifier design, and the classifier itself is fixed once the design process is completed. For in-vehicle driver recognition, the classifier includes a “learning” capability to provide the ability to update itself with the new patterns, i.e., new sets of vehicle settings or the VSS information (arrow 52). That is, the classifier (CL) of FIG. 3 should have a recursive process to incorporate any new patterns into its training patterns so as to accurately update its parameters. Therefore, both the number of classes and the parameters used in the classifier (CL) should be adaptive. This is represented in FIG. 3 by the feedback loop or line 78 representing such incorporation.

The present invention addresses the unique requirements of an in-vehicle driver recognition problem by employing a design based on Gaussian Mixture Models. The term “mixture model” as used herein refers to a model in which independent variables are fractions of a total value. Such a mixture model can be suitable for situations where an observation belongs to one of a number of different sources or categories, but when a source or category to which the observation belongs cannot be measured. In this form of mixture, each of the sources is described by a component probability density function, and its mixture weight is the probability that an observation comes from this component.

A GMM in particular is a specific type of mixture model where all the component probability density functions are Gaussian. Once the number of component models and the corresponding parameters for each component model are known, the source or category, i.e., the class as represented by the component distribution, that a specific observation belongs to can be identified. Since a vehicle is likely to have more than one driver and the vehicle settings of each individual driver are approximately of joint Gaussian distribution, GMMs are suitable for representing the density distribution of the VSS information (arrow 52) of the vehicle 10 shown in FIG. 1.

Therefore, within the scope of the invention GMMs can be used to estimate the density distribution of the VSS information (arrow 52) describing the various vehicle settings, and to identify the current driver based on his/her settings. The GMM-based driver recognition starts when a driver, such as the driver 12 of FIG. 1, enters and starts the vehicle 10. If it is a brand new vehicle and nobody has yet driven it as an authorized user, i.e., N=0, the final feature x₁ (arrow 74) based on the current original features o₁ (arrow 70) is stored, and the GMM is initialized by setting N=1 and P(x)=g(x, μ₁, Σ₁) with μ₁=x₁ and Σ₁=Σ₀, where Σ₀ is the nominal within-subject variance, i.e., a calibrated value that can be determined during the design phase.

On the other hand, if N>0, the DRCS 30 detects whether there is setting adjustment within a certain period of time after the driver 12 enters the vehicle 10. If the driver 12 adjusts the vehicle settings, the algorithm 100 can pause or wait until the adjustment has been completed, e.g., until the vehicle settings have not been changed for T seconds. The algorithm can then conduct feature extraction (FE) and feature selection (FS) using the new setting measurements oᵢ or original features (arrow 70) to generate a new feature setting vector xᵢ=W^{T}oᵢ as the new features (arrow 72). The algorithm 100 then determines the identity of the driver 12 by classifying it into the (N+2 ) classes based on the current GMM with the parameters pₖⁱ⁻¹, μⱼⁱ⁻¹, and Σₖ ⁱ⁻¹,

$$where P ( k \vert {x}_{i} ) = \frac{{p}_{k}^{i - 1} g ( {x}_{i} , \begin{matrix}{μ}_{k}^{i - 1} , & {\sum }_{k}^{i - 1}\end{matrix} )}{{\sum }_{j = 1}^{N} {p}_{k}^{i - 1} g ( {x}_{i} , \begin{matrix}{μ}_{k}^{i - 1} , & {\sum }_{j}^{i - 1}\end{matrix} )} .$$

If P(c|xᵢ)>Pₜₕ for any 1≦k≦N, where Pₜₕ is a pre-determined threshold, the driver has been identified as an existing driver (driver k). The algorithm 100 adds the new feature vector xᵢ (arrow 72) into a data sample set, and updates the GMM model accordingly. The update of the GMM model can be carried out in various ways. For example, equivalent mixing probability p_{c}=1/N can be assumed and the mixing probability gets updated only when a new driver appears. For each driver j, the algorithm 100 stores the most recent Nⱼ (e.g., Nⱼ≦10) feature sets: Xⱼ. As the new feature vector xᵢ (arrow 72) belongs to driver k, only the parameter associated with driver k needs to be updated.

Combining the new feature vector (arrow 72) with the existing feature vectors of driver k results in \tilde{X}_{c}={X_{c}, xᵢ}, μ_{c}ⁱ is updated as the mean of \tilde{X}_{c} and Σⁱ _{c} as the variance of \tilde{X}_{c}. After the update, the oldest feature set in \tilde{X}_{c} is removed if necessary so as to limit the number of feature vectors in X_{c}. The parameters associated with other drivers remain the same: μⁱⱼ=μⁱ⁻¹ⱼ and Σⁱⱼ=Σⁱ⁻¹ⱼ for j≠c (1≦j≦N).

If P(c|xᵢ)≦Pₜₕ, the driver 12 of FIG. 1 is regarded as a new driver. The algorithm 100 increases the number of classes N=N+1, and adds a new Gaussian component distribution, N(μ_{N}⁰, Σ_{N}⁰), where μ_{N}⁰=xᵢ, and Σ_{N}⁰ is the nominal within-subject variance determined in the design phase. If the driver 12 does not adjust the vehicle settings or driver-selected input signals (arrow 48), the algorithm 100 automatically retrieves the previous recognition results and identifies the driver as the driver who last drove the vehicle. As an option, the algorithm 100 may update the mixing probability to reflect that the current driver uses the vehicle 10 one more time.

In accordance with the invention, the process of frequent driver recognition is optimized via a low-cost, relatively precise apparatus and method as set forth above. The identity of a driver such as driver 12 of FIG. 1 can be used to enable enhanced functionality of the vehicle 10. For example, the driver ID information can be used in conjunction with a driver profile management system to provide automatic setting adjustment and/or vehicle control adaptation. Various degrees of autonomous system and/or driving control can be enabled depending on the particular driving style and skill of each authorized driver of the vehicle 10.

The solution provided herein is relatively non-intrusive, as unlike various biometric scanning and user profile-based selections, the driver 12 is not required to take any additional affirmative steps that the driver 12 would not ordinarily take upon entering the vehicle 10. That is, certain predetermined VSS are disproportionately descriptive or sensitive relative to other VSS. These predetermined VSS can be used to model the driver's HDP over time, with the HDP modified as needed by certain other VSS that are more discrete and less variable, such as on/off settings, open/closed settings, discrete position settings, etc.

Over time, the DRCS 30 adapts itself to the driver 12 and various vehicle driving conditions, thus facilitating automatic customization or adjustment of vehicle system settings. For example, once the driver's identity has been established using the vehicle settings or VSS information (arrow 55) as described above, that is, after comparing the driver's most recently entered VSS to various HDP and selecting that driver's HDP, certain control actions can be automatically and seamlessly executed in accordance with that drivers HDP to thereby customize the overall driving experience. Exemplary control actions can include, without being limited to, automatically adjusting or repositioning the mirrors 26S, 26R, the driver seat 24D, the pedals 17, the steering wheel 20, etc. Likewise, the settings for the radio 29R and/or the HVAC 29E of FIG. 2 can be automatically updated based on the driver's identity. The driver 12 is therefore not required to set each of the vehicle settings initially. Once a sufficient number of settings have been entered to affirmatively identify the driver 12, the remaining system settings can be adjusted or modified accordingly. Any changes to one or more settings made by the driver 12 help the DRCS 30 adapt, leading to a more accurate profile for that driver, and thus to an optimized custom response.

While the best modes for carrying out the invention have been described in detail, those familiar with the art to which this invention relates will recognize various alternative designs and embodiments for practicing the invention within the scope of the appended claims.

1. A vehicle comprising:
a plurality of vehicle systems each having a corresponding set of vehicle system settings (VSS), said set of VSS being one of a driver-selectable set of VSS and a driver-adjustable set of VSS; and
a control system operable for statistically modeling said set of VSS to thereby generate a historical driver profile (HDP), and for processing said HDP to thereby determine an identify a driver of the vehicle;
wherein said control system is operable for automatically controlling a setting of at least one of said plurality of vehicle systems using said identity.

2. The vehicle of claim 1, wherein said control system is adapted to statistically model a first predetermined subset of said set of VSS for said driver over time to thereby modify said HDP for said driver.

3. The vehicle of claim 2, wherein said control system is adapted to record a variance and a mean of a second predetermined subset of said set of driver-selectable VSS to thereby modify said HDP for said driver.

4. The vehicle of claim 2, wherein said control system is adapted to automatically update said HDP for said driver when said driver manually changes one of said set of VSS.

5. The vehicle of claim 1, further comprising a driver identification device, wherein said control system is operable for verifying said identity of said one driver using a signal from said driver identification device.

6. The vehicle of claim 5, wherein said driver identification device is selected from the group consisting essentially of: a radio frequency identification (RFID) tag, a key fob, a speech recognition device, and a biometric identification device.

7. The vehicle of claim 1, wherein said control system includes an algorithm having each of a feature extraction subprocess, a feature selection subprocess, and a feature classification subprocess.

8. The vehicle of claim 7, wherein said feature extraction subprocess is a Linear Discriminant Analysis (LDA) subprocess, and wherein said feature classification process is a Gaussian Mixture Model (GMM) subprocess.

9. A method for controlling a predetermined onboard system of a vehicle, the method comprising:
collecting a set of vehicle system settings (VSS) for a plurality of different onboard systems of the vehicle, said set of VSS being one of a driver-selectable set of VSS and a driver-adjustable set of VSS;
processing the set of driver-selectable VSS through a statistical modeling algorithm to thereby determine an identity of a driver of the vehicle; and
automatically controlling the predetermined onboard system using the identity of the driver.

10. The method of claim 9, wherein collecting the set of VSS includes detecting a VSS for at least a pair of said different onboard systems selected from the group consisting of: mirrors, seats, pedals, steering wheel, radio, and an HVAC system.

11. The method of claim 10, wherein processing the set of VSS through a statistical modeling algorithm includes generating an original feature vector collectively describing said set of VSS.

12. The method of claim 11, wherein processing the set of VSS includes transforming said original feature vector using a feature extraction subprocess to thereby generate a new feature vector.

13. The method of claim 12, wherein processing the set of VSS includes processing said new feature vector through a feature selection subprocess to thereby generate a final feature vector.

14. The method of claim 13, wherein processing the set of VSS includes processing said final feature vector through a classification subprocess to thereby determine the identity of the driver.

15. A method for controlling a predetermined onboard system of a vehicle, the method comprising:
collecting a set of driver-selectable vehicle system settings (VSS);
processing the set of driver-selectable VSS through a statistical modeling algorithm utilizing a Gaussian Mixture Model (GMM) to thereby determine an identity of a driver of the vehicle; and
automatically adjusting a setting of the predetermined onboard system using said identity.

16. The method of claim 15, further comprising statistically modeling a plurality of sets of driver-selectable VSS for the driver over time to thereby produce a historical driver profile (HDP).

17. The method of claim 15, wherein processing the set of driver-selectable VSS includes processing the set of driver-selectable VSS through a feature extraction subprocess selected from the group consisting of: Principle Component Analysis (PCA), Linear Discriminant Analysis (LDA), Kernel PCA, and Generalized Discriminant Analysis (GDA).

18. The method of claim 15, wherein processing the set of driver-selectable VSS includes processing the set of driver-selectable VSS through a feature selection subprocess selected from the group consisting of: Exhaustive Search, Branch- and Bound Search, Sequential Forward/Backward Selection, and Sequential Forward/Backward Floating Search.
